(19) United States
(12) Patent Application Publication
(10) Pub. No.: US 2006/0049092 A1
(43) Pub. Date: Mar. 9, 2006

(54) Membrane bioreactor

(76) Inventors: Joseph Kuo, Taichung City (TW); Ben Chang, Chia-Yi City (TW)

Correspondence Address: QUINE INTELLECTUAL PROPERTY LAW GROUP, P.C., P O BOX 458, ALAMEDA, CA, 94501, US

(21) Appl. No.: 10/938,733

(22) Filed: Sep. 9, 2004

(51) Int. Cl. B01D 63/00

(52) U.S. Cl. 210/321.6; 210/321.72; 210/456; 210/335

(57) ABSTRACT

A membrane bioreactor includes a tank, a porous pre-filtering element mounted in the tank for conducting a primary filtration of wastewater, at least one membrane module mounted in the tank and disposed downstream of the porous pre-filtering element for conducting a secondary filtration of the wastewater, and a turbulent flow-forming unit. The membrane module cooperates with the porous pre-filtering element or another membrane module to define a compartment therebetween for receiving the wastewater pretreated by the porous pre-filtering element. The turbulent flow-forming unit is associated with the compartment for generating turbulent flow in the compartment.

### BACKGROUND OF THE INVENTION

1. Field of the Invention

This invention relates to a membrane bioreactor, more particularly to a membrane bioreactor that includes a porous pre-filtering element, a membrane module and a turbulent flow-forming unit.

2. Description of the Related Art

Up to now, secondary treatment of municipal wastewater is commonly conducted by activated sludge treatment (AST). Although the conventional AST has been utilized for many years, it requires control of sludge concentration and relatively large space for separation of suspended solids, and has drawbacks including a slow reaction rate and unstable quality of permeate after treatment. In addition, the conventional AST is uneconomical because expensive landfill is required to dispose the sludge produced therefrom.

Recently, membrane bioreactor (MBR) has superseded the conventional AST in wastewater secondary treatment. The membrane bioreactor combines bio-treatment techniques and membrane separation techniques, and includes a bio-membrane module, which is classified into external type and internal type, in a reaction tank of the conventional AST. Particularly, wastewater contacts micro-organisms that exist in the sludge in the reaction tank so as to conduct a decomposition reaction. The mixture obtained after the decomposition reaction is driven by a sufficient differential pressure so as to pass through a biomembrane of the biomembrane module. The water thus treated is discharged from the biomembrane module, and the sludge thus formed is left in the react-ion tank. The membrane bioreactor functions to decompose organic materials and to separate the sludge from the treated water. As such, the membrane bioreactor can be used as a substitute for the secondary sedimentation and the gravity sedimentation in the conventional AST.

The membrane bioreactor is suitable for treating sludge with a high concentration range, achieving an effective solid-liquid separation, and minimizing the reaction tank volume and the amount of sludge formed in the reaction tank. Thus, the problem encountered in the conventional activated sludge treatment, i.e. the quality of discharging water cannot be further improved, can be solved by using the membrane bioreactor so as to meet stringent environmental requirements for discharging water. A variety of commercial membrane bioreactors have been developed since 1980, such as hollow fiber membranes adopted by ZENON company, Canada, which have a relatively large interceptive surface area per unit volume, and flat sheet membranes adopted by KUBOTA company, Japan.

In view of the foregoing, current hollow fiber membranes or flat sheet membranes still have the following drawbacks, which mandate further improvement:

1. Membranes tend to get fouled because of adhesion of a mass of microorganisms and phlegmatic materials.

2. Maintenance cost is high. Since the membranes have a tendency to get fouled, more membrane modules are required to increase the surface area of the membranes so as to increase wastewater flux through the membranes.

3. Cleaning of the membranes, such as the hollow fiber membranes, is laborious.

In addition, the membrane bioreactor can be classified into two major types pursuant to disposition, i.e. the external type (or the branched type) and the internal type (or the submerged type) As shown in FIG. 1, the external type membrane bioreactor 1 includes a reaction tank 101 and a membrane module 102 disposed outside of the reaction tank 101. Wastewater stored in the reaction tank 101 is pumped into the membrane module 102 at a high flow rate for conducting filtration operations.

FIG. 2 illustrates an internal type membrane bioreactor 2 including a reaction tank 201 and a membrane module 202 disposed in the reaction tank 202. Wastewater stored in the reaction tank 201 is passed and is filtered through the membrane module 202 by virtue of a negative differential pressure between inner and outer sides of the membrane module 202 generated by a pump.

In practice, the external type membrane bioreactor 1 occupies a relatively large space, and consumes a large amount of energy due to the use of positive differential pressure and cross-flow operation. In addition, the membrane module 102 is required to be cleaned frequently because the membrane is susceptible to fouling under a relatively high flux of wastewater. Thus, the operational cost is relatively high. On the other hand, the internal type membrane bioreactor 2 is space-saving because the membrane module 202 is submerged in the reaction tank 201, and is energy-saving because the membrane of the membrane module 202 has a relatively large surface area. However, the wastewater flux of the membrane module 202 is relatively low as compared to that of the external type membrane module 1. Besides, the membrane module 202 cannot be cleaned conveniently because the membrane module 202 is required to be removed from the membrane bioreactor 2. Apparently, the external type and the internal type membrane bioreactors 1, 2 both have their own disadvantages that require further improvement. The focus of current research for improving the membrane bioreactor is on how to increase the wastewater flux. However, these improvements normally result in a high operation cost. Therefore, there is a need in the art to provide an apparatus capable of minimizing membrane fouling under a high wastewater flux so as to prolong the service life of the membrane module.

### SUMMARY OF THE INVENTION

According to one aspect of the present invention, a membrane bioreactor includes: a tank adapted to receive wastewater therein; a porous pre-filtering element mounted in the tank for conducting a primary filtration of the wastewater; a membrane module mounted in the tank and disposed downstream of the porous pre-filtering element for conducting a secondary filtration of the wastewater pretreated by the porous pre-filtering element, the membrane module cooperating with the porous pre-filtering element to define a compartment therebetween for receiving the wastewater pretreated by the porous pre-filtering element; and a turbulent flow-forming unit associated with the compartment for generating turbulent flow in the compartment.

According to another aspect of the present invention, a membrane bioreactor includes a porous pre-filtering unit adapted to receive wastewater for conducting a primary filtration of the wastewater; a membrane filtering unit disposed downstream of the porous pre-filtering unit for conducting a secondary filtration of the wastewater pretreated by the porous pre-filtering unit, the membrane filtering unit including first and second membrane modules that cooperatively define a compartment therebetween for receiving the wastewater pretreated by the porous pre-filtering unit; and a turbulent flow-forming unit associated with the compartment for generating turbulent flow in the compartment.

### BRIEF DESCRIPTION OF THE DRAWINGS

Other features and advantages of the present invention will become apparent in the following detailed description of the preferred embodiments of the invention, with reference to the accompanying drawings. In the drawings:

FIG. 1 is a schematic view to illustrate a conventional external type membrane bioreactor;

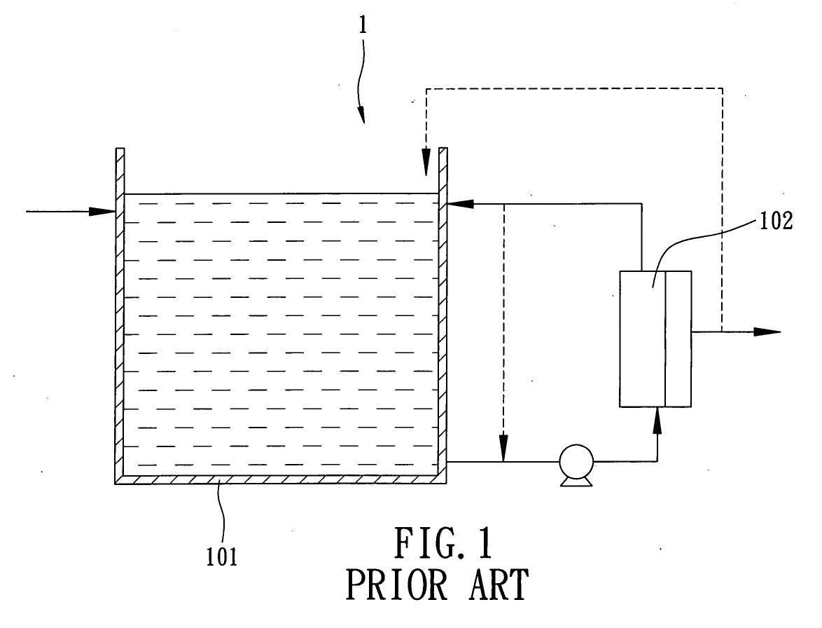

FIG. 2 is a schematic view to illustrate a conventional internal type membrane bioreactor;

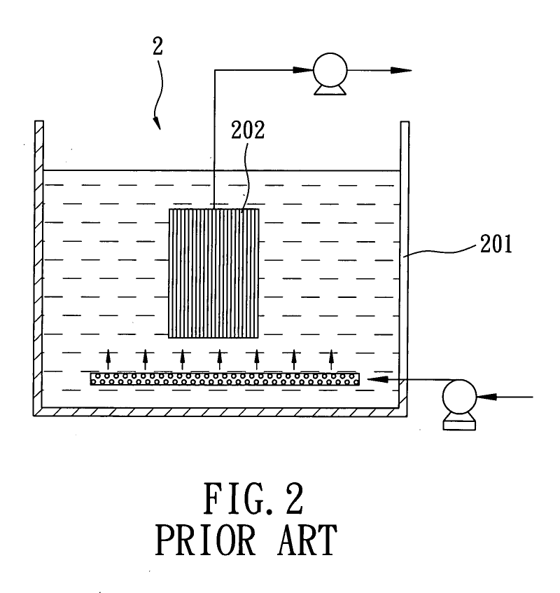

FIG. 3 is a schematic view to illustrate the first preferred embodiment of a membrane bioreactor according to this invention;

FIG. 4 is a perspective view of a turbulent flow-forming unit included in the membrane bioreactor shown in FIG. 3;

FIG. 5 is a schematic view to illustrate the second preferred embodiment of the membrane bioreactor according to this invention; and

FIG. 6 is a schematic view to illustrate the third preferred embodiment of a membrane bioreactor according to this invention.

### DETAILED DESCRIPTION OF THE PREFERRED EMBODIMENTS

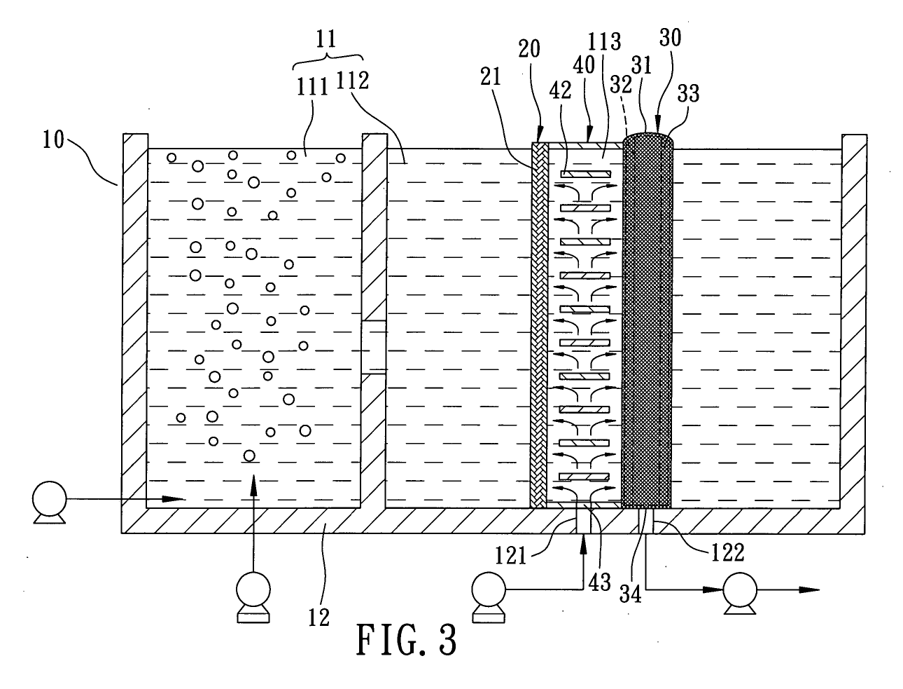

Referring to FIG. 3, the first preferred embodiment of a membrane bioreactor according to this invention includes a tank 10, a porous pre-filtering element 20 disposed in the tank 10, a membrane module 30 disposed in the tank 10, and a turbulent flow-forming unit 40 disposed between the porous pre-filtering element 20 and the membrane module 30.

The tank 10 defines an inner space 11 therein, and has a bottom wall 12. The inner space 11 is adapted to receive wastewater, and is divided into first and second compartments 111, 112 that are in fluid communication with each other. In the first compartment 111, suspended solids in the wastewater are removed. The detailed descriptions regarding the operations conducted in the first compartment 111 are omitted herein since these are not pertinent to the technical features of the present invention and can be readily appreciated by those skilled in the art.

The porous pre-filtering element 20, the membrane module 30 and the turbulent flow-forming unit 40 are disposed in the second compartment 112. The primary filtration of the wastewater is conducted through the porous pre-filtering element 20. The membrane module 30 is disposed downstream of the porous pre-filtering element 20 for conducting a secondary filtration of the wastewater pretreated by the porous pre-filtering element 20. The membrane module 30 cooperates with the porous pre-filtering element 20 to define a third compartment 113 therebetween for receiving the wastewater pretreated by the porous pre-filtering element 20. The turbulent flow-forming unit 40 is associated with the third compartment 113 for generating turbulent flow in the third compartment 113. In this embodiment, the turbulent flow-forming unit 40 is disposed in the third compartment 113.

The bottom wall 12 of the tank 10 is formed with an inlet 121 under the turbulent flow-forming unit 40, and an outlet 122 in fluid communication with the membrane module 30.

Preferably, the porous pre-filtering element 20 is mounted removably in the second compartment 112 of the tank 10, and has a plurality of pores 21. The porous pre-filtering element 20 may be made from a material selected from the group consisting of sponge and non-woven fabric materials. Preferably, the pores 21 of the porous pre-filtering element 20 have a pore size ranging from 50 μm to 500 μm.

The membrane module 30 includes an outer porous membrane 31 that permits growth of microorganisms thereon, and an inner supporting mesh 32 that is enclosed by the outer porous membrane 31. The outer porous membrane 31 has a plurality of pores 33. Preferably, the outer porous membrane 31 is an ultra-filtration membrane made from polyvinylidene fluoride (PVDF). The pores 33 of the outer porous membrane 31 preferably have a pore size smaller than that of the pores 21 of the porous pre-filtering element 20. Preferably, the pore size of the pores 33 of the outer porous membrane 31 ranges from 0.01 to 0.4 μm. The membrane module 30 has an outlet 34 connected to the outlet 122 of the bottom wall 12 of the tank 10 so as to discharge the wastewater after treatment.

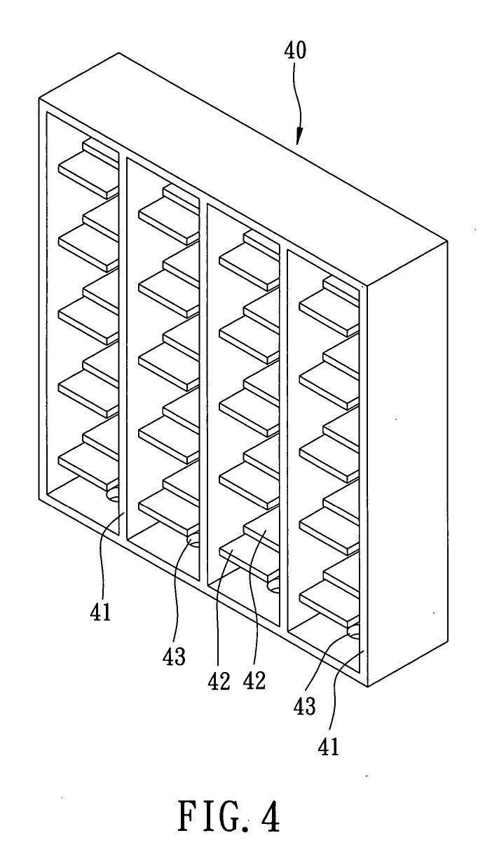

As shown in FIGS. 3 and 4, the turbulent flow-forming unit 40 includes a flow-dividing member mounted in the third compartment 113. The flow-dividing member has a supporting frame including a plurality of standing plates 41 extending in a vertical direction perpendicular to a flow direction of the wastewater passing through the porous pre-filtering element 20, and a plurality of baffles 42 mounted on the standing plates 41 and aligned in the vertical direction.

The supporting frame of the turbulent flow-forming unit 40 further includes a bottom plate that is formed with bottom holes 43 that are registered with the inlet 121 of the bottom wall 12 of the tank 10. The turbulent flow-forming unit 40 further includes a gas-supplying member for supplying gas into the third compartment 113 through the inlet 121 of the tank 10 and the bottom holes 43 in the bottom plate of the supporting frame. The baffles 42 of the flow-dividing member are arranged in such a manner to permit the gas supplied into the third compartment 113 to flow in a meandering manner along the vertical direction.

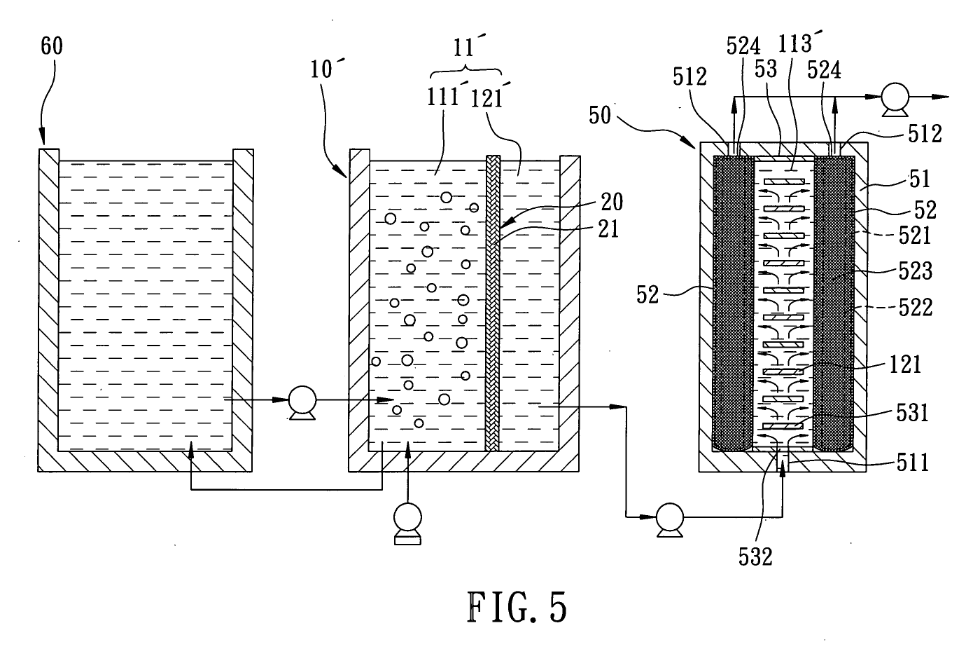

Referring to FIG. 5, the second preferred embodiment of the membrane bioreactor according to this invention includes a pre-treatment tank 60, a porous pre-filtering unit adapted to receive wastewater for conducting a primary filtration of wastewater, and a membrane filtering unit 50 disposed downstream of the porous pre-filtering unit for conducting a secondary filtration of the wastewater pretreated by the porous pre-filtering unit.

The porous pre-filtering unit includes a filtering tank 10′ that defines an inner space 11′ therein. A porous pre-filtering element 20, which has a structure similar to that of the porous pre-filtering element 20 shown in FIG. 3, is mounted in the filtering tank 10′ and divides the inner space 11′ of the filtering tank 10′ into first and second compartments 111′, 112′. The wastewater, after removal of suspended solids in the first compartment 111′, is filtered by passing through the porous pre-filtering element 20 and into the second compartment 112′. The wastewater in the second compartment 112′ is then pumped into the membrane filtering unit 50 for secondary filtration.

The membrane filtering unit 50 includes a membrane tank 51 and first and second membrane modules 52 that are disposed in the membrane tank 51 and that cooperatively define a third compartment 113′ therebetween for receiving the wastewater pretreated by the porous pre-filtering element 20, and a turbulent flow-forming unit 53 associated with the third compartment 113′ for generating turbulent flow in the third compartment 113′. In this embodiment, the turbulent flow-forming unit 53 is disposed in the third compartment 113′.

The membrane tank 51 has an inlet 511 for receiving the wastewater pretreated by the porous pre-filtering unit and stored in the second compartment 112′, and two outlets 512. Each of the first and second membrane modules 52 has a discharging outlet 524 that is registered and that is in fluid communication with a respective one of the outlets 512 of the membrane tank 51 so as to permit discharging of the wastewater therefrom.

The turbulent flow-forming unit 53 includes a flow-dividing member that is mounted in the third compartment 113′ in the membrane tank 51. The flow-dividing member has a structure similar to that of the flow-dividing member of the turbulent flow-forming unit 40 shown in FIG. 4. The flow-dividing member of the turbulent flow-forming unit 53 includes a supporting frame having a plurality of standing plates and a plurality of baffles 531 mounted on the standing plates and aligned in a vertical direction that is perpendicular to a flow direction of the wastewater passing through a respective one of the first and second membrane modules 52. In addition, the supporting frame of the flow-dividing member of the turbulent flow-forming unit 53 further has a bottom plate that is formed with a bottom hole 532 registered and in fluid communication with the inlet 511 of the membrane tank 51. The turbulent flow-forming unit 50 further includes a wastewater supplying member for supplying the wastewater pretreated by the porous pre-filtering unit from the second compartment 112′ of the tank filtering 10′ of the porous pre-filtering unit to the third compartment 113′ through the inlet 511 of the membrane tank 51 and the bottom hole 532 in the bottom plate of the supporting frame of the flow-dividing member of the turbulent flow-forming unit 53. The baffles 531 of the flow-dividing member of the turbulent flow-forming unit 53 are arranged in such a manner to permit the wastewater that enters into the third compartment 113′ to flow in a meandering manner along the vertical direction.

Each of the first and second membrane modules 52 has a structure similar to that of the membrane module 30 shown in FIG. 3, and includes an outer porous membrane 521 that permits growth of microorganisms thereon, and an inner supporting mesh 522 that is enclosed by the outer porous membrane 521. In addition, the outer porous membrane 521 of each of the first and second membrane modules 52 has a plurality of pores 523. The pores 523 have a pore size smaller than that of the pores 21 of the porous pre-filtering element 20.

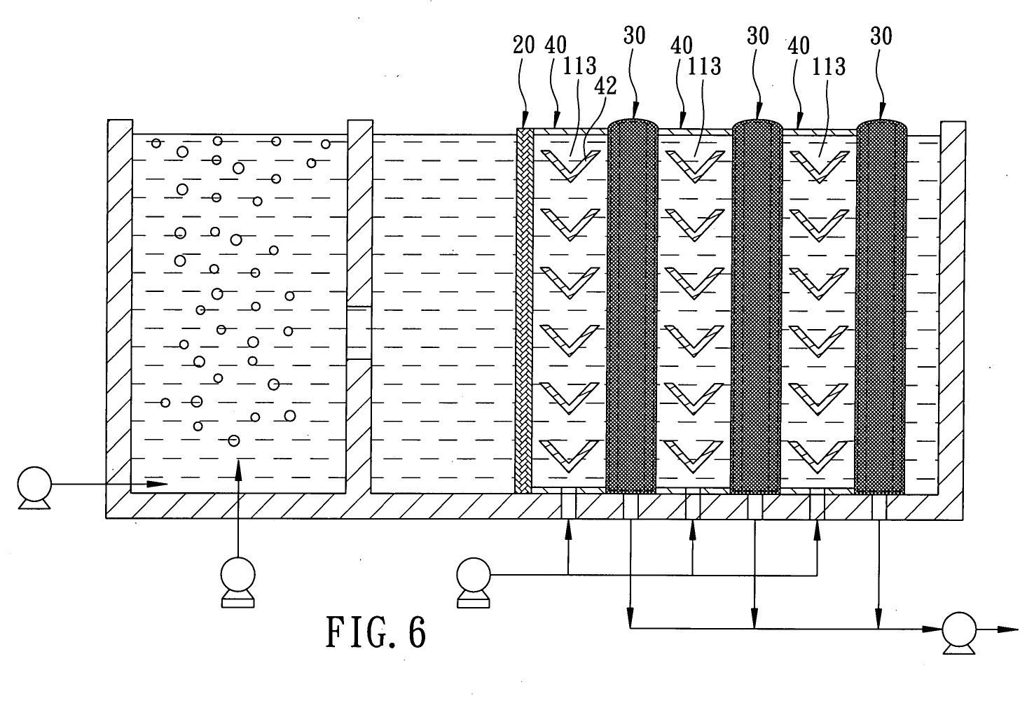

Referring to FIG. 6, the third preferred embodiment of a membrane bioreactor according to this invention is illustrated. The membrane bioreactor of this embodiment has a similar construction and arrangement as compared to the membrane bioreactor of the first preferred embodiment shown in FIG. 3, except that there are first, second and third membrane modules 30 and three turbulent flow-forming units 40 included in this embodiment. Two adjacent ones of the porous pre-filtering element 20, and the first, second, and third membrane modules 30 cooperate to define a third compartment 113. The turbulent flow-forming units 40 are disposed respectively in the third compartments 113.

Preferably, in this embodiment, each of the baffles 42 has a V-shaped cross-section.

In view of the foregoing, the suspended solids having a relatively large particle size in the wastewater are removed by passing through the porous pre-filtering element 20. Then, the pretreated wastewater flows into the third compartment 113 (113′), and is subsequently pumped out of the membrane bioreactor. Strong turbulent flow is generated in the third compartment 113 (113′) by virtue of the turbulent flow-forming unit 40 (52), and acts on the outer porous membrane 31 (521) so as to minimize fouling of the membrane module 30 (52). Therefore, the cleaning frequency of the membrane module 30 (52) is significantly decreased, and the operational life of the membrane module 30 (52) is prolonged.

In addition, in the first and third embodiments, the wastewater turbulent flow formed in the compartment 113 also acts on the porous pre-filtering element 20 so as to avoid fouling of the porous pre-filtering element 20. Therefore, the cleaning frequency of the porous pre-filtering element 20 is also decreased, and the operational life of the porous pre-filtering element 20 is prolonged. Furthermore, the porous pre-filtering element 20 is made from inexpensive materials, such as sponge or non-woven fabric materials, and can be replaced periodically.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

What is claimed is:

1. A membrane bioreactor, comprising:
a tank adapted to receive wastewater therein;
a porous pre-filtering element mounted in said tank for conducting a primary filtration of the wastewater;
a membrane module mounted in said tank and disposed downstream of said porous pre-filtering element for conducting a secondary filtration of the wastewater pretreated by said porous pre-filtering element, said membrane module cooperating with said porous pre-filtering element to define a compartment therebetween for receiving the wastewater pretreated by said porous pre-filtering element; and
a turbulent flow-forming unit associated with said compartment for generating turbulent flow in said compartment.

2. The membrane bioreactor of claim 1, wherein said turbulent flow-forming unit includes a flow-dividing member that is mounted in said compartment and that has
a supporting frame including a plurality of standing plates extending in a vertical direction perpendicular to a flow direction of the wastewater passing through said porous pre-filtering element, and
a plurality of baffles mounted on said standing plates and aligned in the vertical direction.

3. The membrane bioreactor of claim 2, wherein each of said baffles has a V-shaped cross-section.

4. The membrane bioreactor of claim 2, wherein said tank has an inlet, said supporting frame further including a bottom plate that is formed with a bottom hole registered and in fluid communication with said inlet of said tank, said turbulent flow-forming unit further including a gas supplying member for supplying gas into said compartment through said inlet of said tank and said bottom hole in said bottom plate of said supporting frame, said baffles of said flow-dividing member being arranged in such a manner to permit the gas in said compartment to flow in a meandering manner along the vertical direction.

5. The membrane bioreactor of claim 1, wherein said membrane module includes an outer porous membrane that permits growth of microorganisms thereon, and an inner supporting mesh that is enclosed by said outer porous membrane, and has an outlet for discharging the wastewater treated by said membrane module therefrom.

6. The membrane bioreactor of claim 5, wherein said outer porous membrane of said membrane module has a pore size smaller than that of said porous pre-filtering element.

7. The membrane bioreactor of claim 1, wherein said porous pre-filtering element is made from a material selected from the group consisting of sponge and non-woven fabric materials.

8. A membrane bioreactor comprising:
a porous pre-filtering unit adapted to receive wastewater for conducting a primary filtration of the wastewater;
a membrane filtering unit disposed downstream of said porous pre-filtering unit for conducting a secondary filtration of the wastewater pretreated by said porous pre-filtering unit, said membrane filtering unit including first and second membrane modules that cooperatively define a compartment therebetween for receiving the wastewater pretreated by said porous pre-filtering unit; and
a turbulent flow-forming unit associated with said compartment for generating turbulent flow in said compartment.

9. The membrane bioreactor of claim 8, wherein said porous pre-filtering unit includes a tank, and a porous pre-filtering element mounted in said tank.

10. The membrane bioreactor of claim 9, wherein said membrane filtering unit further includes a membrane tank having an inlet for receiving the wastewater pretreated by said porous pre-filtering unit, and two outlets, said first and second membrane modules being mounted in said membrane tank, each of said first and second membrane modules having a discharging outlet that is registered and in fluid communication with a respective one of said outlets of said membrane tank so as to permit discharging of the wastewater therefrom.

11. The membrane bioreactor of claim 10, wherein said turbulent flow-forming unit includes a flow-dividing member that is mounted in said compartment in said membrane tank and that includes a supporting frame having a plurality of standing plates, and a plurality of baffles mounted on said standing plates and aligned in a vertical direction that is perpendicular to a flow direction of the wastewater passing through a respective one of said first and second membrane modules.

12. The membrane bioreactor of claim 11, wherein said supporting frame further has a bottom plate that is formed with a bottom hole registered and in fluid communication with said inlet of said membrane tank, said turbulent flow-forming unit further including a wastewater supplying member for supplying the wastewater pretreated by said porous pre-filtering unit to said compartment through said inlet of said membrane tank and said bottom hole in said bottom plate of said supporting frame, said baffles being arranged in such a manner to permit the wastewater to flow in a meandering manner along the vertical direction.

13. The membrane bioreactor of claim 12, wherein each of said first and second membrane modules includes an outer porous membrane that permits growth of microorganisms thereon, and an inner supporting mesh that is enclosed by said outer porous membrane.

14. The membrane bioreactor of claim 13, wherein said outer porous membrane of each of said first and second membrane modules has a pore size smaller than that of said porous pre-filtering element.

15. The membrane bioreactor of claim 9, wherein said porous pre-filtering element is made from a material selected from the group consisting of sponge and non-woven fabric materials.
